(19) United States
(12) Patent Application Publication
(10) Pub. No.: US 2022/0249322 A1
(43) Pub. Date: Aug. 11, 2022

(54) AUTO CYCLE LUMBAR MASSAGE SYSTEM AND METHOD OF OPERATING THE SAME

(71) Applicant: HHC CHANGZHOU CORPORATION, CHANGZHOU (CN)

(72) Inventors: CHIH HSIUNG LIU, Benoni (ZA); MEI JUN XU, JIUJIANG (CN); XIAO PING RAN, XICHONG (CN)

(21) Appl. No.: 17/174,271

(22) Filed: Feb. 11, 2021

(51) Int. Cl. A61H 37/00

(52) U.S. Cl. CPC A61H 37/00; A61H 2201/0149; A61H 2201/1642; A61H 2201/5023; A61H 2201/1607; A61H 2205/081

(57) ABSTRACT

The present invention relates to a piece of furniture within which a massage system has been incorporated so as to provide a person, sitting in the piece of furniture, with massage capabilities so as to relieve pressure, stress, and/or tension. The system comprises a lumbar actuator which is adapted to engage a lumbar portion of the piece of furniture, wherein the lumbar actuator will be cyclically activated in accordance with single or multiple frequencies or modes of operation so as to provide the person, sitting in the piece of furniture, with varying degrees of massage as may be desired by the user or person sitting in the piece of furniture.

### FIELD OF THE INVENTION

The present invention relates generally to furniture, and more particularly to a household or office furniture piece which may comprise, for example, a lounger chair, an armchair, a sofa, or similar type piece of furniture, within which a massage system has been incorporated so as to provide a person, sitting in the chair, sofa, or similar type piece of furniture, with massage capabilities so as to relieve pressure, stress, and/or tension.

### BACKGROUND OF THE INVENTION

In the current global economy, competition is fierce, people are busy working, and there are always a multitude of production and shipping deadlines to be met in accordance with various different product purchasing contracts. In short, working people and business executives at all levels of business are under a great deal of pressure, stress, and tension. In order to effectively relieve such pressure, stress, and tension, which can, in turn, result in fatigue which, of course, is counter-productive in achieving work-related goals, many people are turning to massage therapy. Conventional chairs and other furniture pieces, designed to provide some type of massage, usually have mechanisms incorporated therein which provide variations of kneading, vibration, knocking, and the like, and have not really proven to be reliable in delivering the type of massage that is desired in order to reduce pressure, stress, tension, and the like. The reason for this is that such conventional chairs and other furniture pieces do not actually target the correct part of the body and provide the necessary massage to that region of the body. One of the most important parts of the body to be massaged in order to effectively reduce pressure, stress, tension, and the like, is a person's back, and more particularly, the lumbar region of the back.

A need therefore exists in the art for a new and improved piece of furniture. An additional need exists in the art for a new and improved piece of furniture that can provide a particular type of massage that can in fact help to reduce pressure, stress, tension, and the like. A further need exists in the art for a new and improved piece of furniture that can in fact help to reduce pressure, stress, tension, or the like, as a result of a massage mechanism incorporated within the piece of furniture that targets the correct part of the body and provide the necessary massage to that region of the body. A still further need exists in the art for a new and improved piece of furniture that can in fact help to reduce pressure, stress, tension, or the like, as a result of a massage mechanism incorporated within the piece of furniture that targets the correct part of the body and provide the necessary massage to that region of the body, wherein that part of the body is the back region of the body, and more particularly, the lumbar region of the body.

### OVERALL OBJECTIVES OF THE PRESENT INVENTION

An overall objective of the present invention is to provide a new and improved piece of furniture. An additional overall objective of the present invention is to provide a new and improved piece of furniture that can provide a particular type of massage that can in fact help to reduce pressure, stress, tension, and the like. A further overall objective of the present invention is to provide a new and improved piece of furniture that can in fact help to reduce pressure, stress, tension, or the like, as a result of a massage mechanism incorporated within the piece of furniture that targets the correct part of the body and provide the necessary massage to that region of the body. A still further overall objective of the present invention is to provide a new and improved piece of furniture that can in fact help to reduce pressure, stress, tension, or the like, as a result of a massage mechanism incorporated within the piece of furniture that targets the correct part of the body and provide the necessary massage to that region of the body, wherein that part of the body is the back region of the body, and more particularly, the lumbar region of the body.

### SUMMARY OF THE INVENTION

In accordance with the principles and teachings of the present invention, there has been developed a new and improved chair, sofa, or similar type of furniture piece wherein a lumbar actuator has been incorporated therein so as to engage the lumbar region of the back of a person sitting in the chair, sofa, or similar type of furniture piece. More particularly, the chair, sofa, or similar type of furniture piece, is provided with a main actuator which will conventionally move or actuate various parts of the furniture piece, such as, for example, the back portion of the furniture, and the footrest portion of the furniture piece. In addition, the furniture piece is provided with a headrest actuator which will move the headrest through predetermined incremental movements such that the headrest is disposed at a particular predetermined position as desired by the user, and a lumbar actuator which will move a lumbar support member to a predetermined extended position with respect to the person's lumbar region of the person's back, and will retract the lumber support member back to its original position. A switch housing is provided upon a side of the furniture piece and is electronically connected to a control box so as to initiate movement of the various actuators so as to, in turn, move the various components of the furniture piece between extended and retracted positions. In connection with the lumbar actuator and the lumber support member, several different modes of operation are envisioned. For example, a first button can be depressed such that the lumbar actuator may simply be extended so as to, in turn, move the lumber support member to a predetermined extended position so as to provide necessary support and comfort to the lumbar region of the back of the person sitting in the furniture piece. Alternatively, a second button may be depressed such that the lumbar actuator may be cyclically extended and retracted in accordance with a predetermined frequency pattern so as to provide the user, seated in the furniture piece, with a massage that will promote blood circulation, comfort, and physical and mental relaxation. Still further, in accordance with a third mode of operation, when the second button is depressed, the lumbar actuator can be extended and retracted in accordance with varying degrees of frequency patterns similar to, for example, heated seats within modern automotive vehicles, so as to, in turn, achieve different modes of massage as may be desired by the person sitting in the furniture piece. More particularly, as is well known with respect to heated seat systems installed within modern automotive vehicles, when one depresses a button once, the heating mechanism for heating the seats is activated to a first degree, and if the button is depressed a second time, the heating mechanism for heating the seats is activated to a second degree. Likewise, if the button is depressed a third time, the heating mechanism for heating the seats is activated to a third degree, while depressing the button a fourth time terminates the heating system such that the seats are no longer heated. In a similar manner, depression of the second lumbar massage button can actuate the lumbar actuator in accordance with varying degrees of frequency such that the lumbar massage system can provide varying degrees of massage to the person seated in the chair or other piece of furniture so as to, in turn, achieve varying degrees of massage, comfort, and mental and physical relaxation as may be desired by the user.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a front, right side, top perspective view of a conventional PRIOR ART recliner chair illustrating one type of furniture piece within which the system of the present invention can be incorporated;

FIG. 2 is a schematic view of an AC power cable adapted to be electrically connected at one end thereof to a suitable source of AC power;

FIG. 3 is a schematic view of an AC/DC adapter which is adapted to be connected at one end thereof to a second end of the AC power cable, as illustrated within FIG. 2, for converting AC current to DC current;

FIG. 4 is a schematic view of a DC power cable which is adapted to be electrically connected at one end thereof to a second end of the AC/DC adapter, as illustrated within FIG. 3, for receiving DC current from the AC/DC adapter;

FIG. 5 is a schematic view of a main actuator which is adapted to be connected at one end thereof to a second end of the DC power cable, as illustrated within FIG. 4, so as to receive DC current from the DC power cable;

FIG. 6 is a schematic view of a headrest actuator which is adapted to be electrically connected to the main actuator as illustrated within FIG. 5;

FIG. 7 is a schematic view of a lumbar actuator which is adapted to be electrically connected to the main actuator as illustrated within FIG. 5;

FIG. 8 is a schematic view of a control box which is adapted to be electrically connected at one end thereof to the main actuator as illustrated within FIG. 5;

FIG. 9 is a schematic view of a side switch housing which is adapted to be mounted upon one side of the chair illustrated within FIG. 1, and is also adapted to be electrically connected to a second end of the control box as illustrated within FIG. 8, and wherein the side switch comprises several buttons which may be depressed so as to control the various lumbar, headrest, and main actuators, as well as a USB port for enabling the charging of various electronic devices, such as, for example, a mobile phone; and

FIG. 10 is a schematic block diagram illustrating how all of the various components of the system, as illustrated within FIGS. 2-9, are electrically connected to each other in accordance with the principles and teachings of the present invention so as to provide the chair, as illustrated within FIG. 1, with the desired chair, headrest, and lumbar movements.

### DETAILED DESCRIPTION OF THE PREFERRED EMBODIMENT

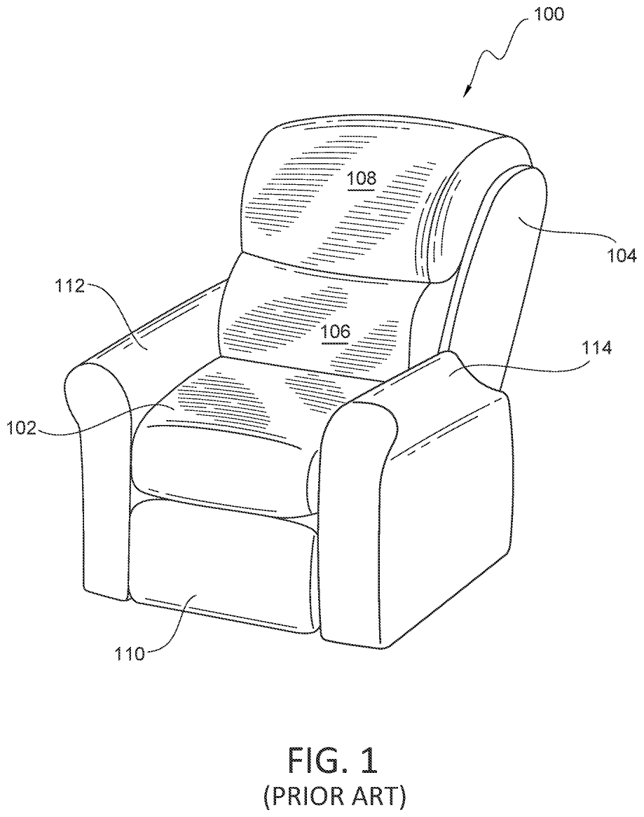

With reference first being made to FIG. 1, a conventional, PRIOR ART, lounger chair is disclosed and is generally indicated by the reference character 100. Chair 100 comprises a typical lounger chair which comprises a seat portion 102, a back portion 104 which may be moved between various positions between an upright position and a reclined position, a lumbar support portion 106 which is effectively part of the back portion 104 but which is positionally located so as to be capable of engaging the lumbar region of the back of the torso of the person seated in the chair 100, a headrest portion 108 which may be moved to various positions as desired by a person seated in the chair 100 such that the headrest portion 108 is disposed at a position that the person seated in the chair 100 finds most comfortable. In addition, the chair 100 further comprises a footrest portion 110 which, in a manner similar to that of the headrest portion 108, may be moved to various positions as desired by a person seated in the chair 100 such that the footrest portion 110 is disposed at a position that the person seated in the chair 100 finds most comfortable. Lastly, the chair 100 comprises a pair of oppositely disposed armrest portions 112,114.

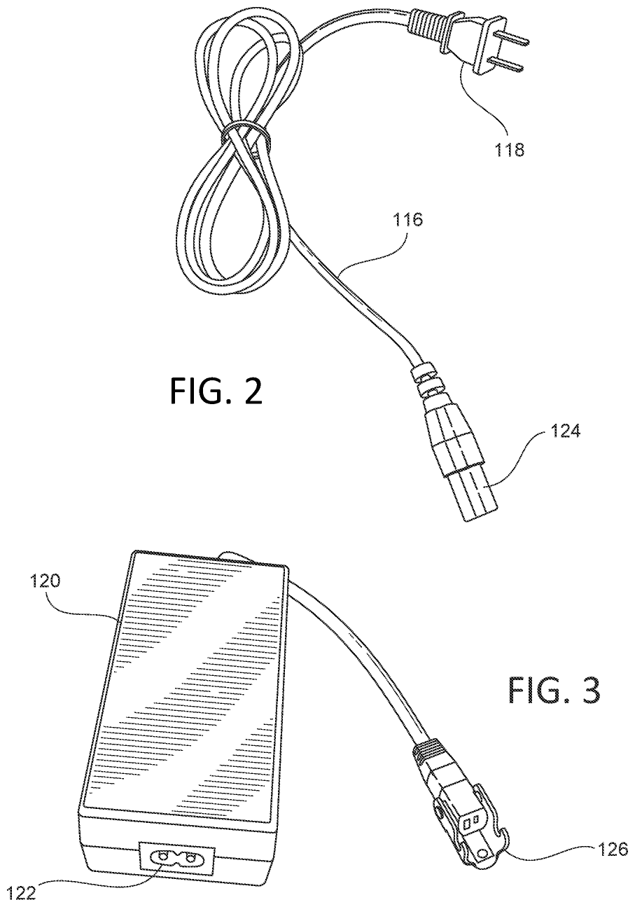

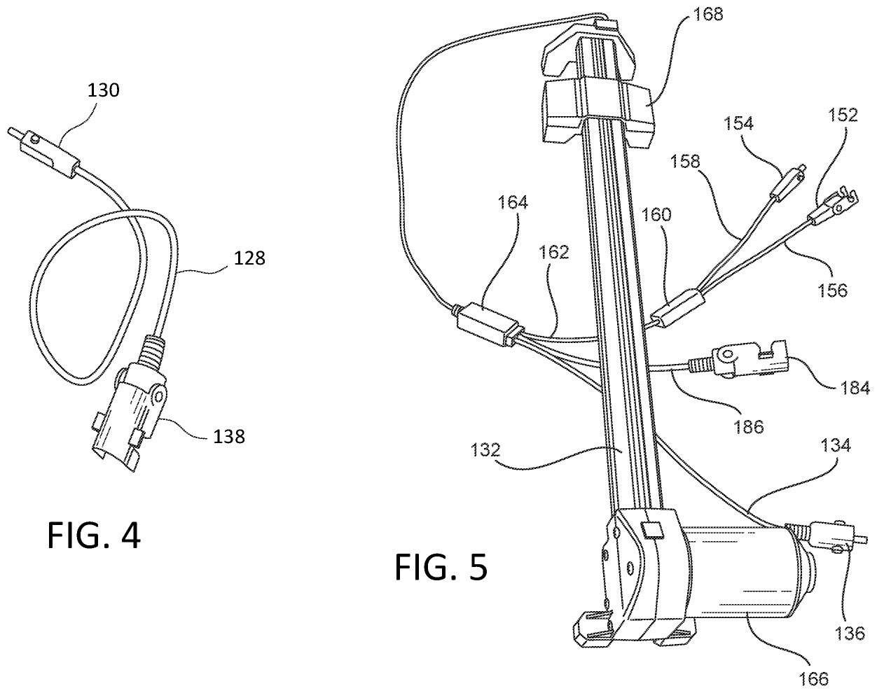

In accordance with the principles and teachings of the present invention, and with reference being made to FIGS. 2-10, there has been developed a new and improved chair, sofa, or other type of furniture piece, similar to the chair 100, wherein a lumbar actuator system has been incorporated therein so as to engage the lumbar region of the back of a person sitting in the chair, sofa, or similar type of furniture piece, in accordance with different modes of operation so as to either provide support to the lumbar region of the back portion of the torso of the person sitting in the chair or other furniture piece, or to provide different modes of massage to the lumbar region of the back portion of the torso of the person sitting in the chair or other furniture piece. More particularly, as can best be appreciated from FIGS. 2 and 3, the lumbar massage system comprises an AC power cable 116 which is adapted to be electrically connected at a first end thereof to a suitable source of AC power by means of a conventional plug 118, and an AC/DC adapter 120 which is provided with a socket 122 at a first end thereof to which a second end of the AC power cable 116 is adapted to be electrically connected by means of a suitable plug 124 which is to be inserted into the socket 122 of the AC/DC adapter 120, the AC/DC adapter 120 of course being provided to convert AC power or current to DC power or current. Accordingly, the AC/DC adapter 120 is provided with a suitable electrical connector 126 at a second opposite end thereof for outputting DC power from the AC/DC adapter. In turn, as can best be appreciated from FIG. 4, a DC power cable 128 is adapted to be electrically connected to the AC/DC adapter 120 by means of a suitable electrical connector 130, which is provided upon a first end of the DC power cable 120, wherein the electrical connector 130 of the DC power cable is adapted to be electrically connected to the electrical connector 126 of the AC/DC adapter 120 so as to receive DC power or current from the AC/DC adapter 120.

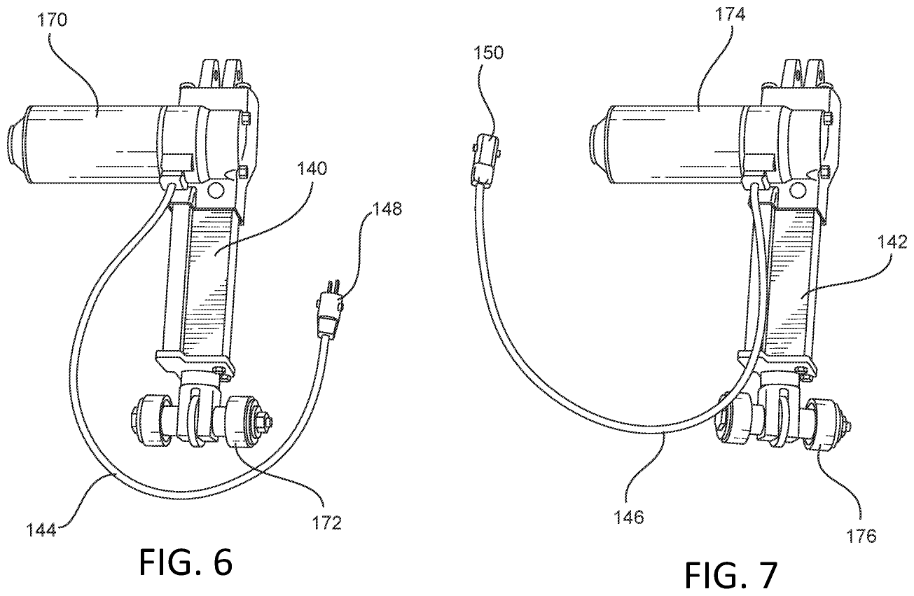

Continuing further, and with reference being made to FIG. 5, a main actuator 132 is disclosed, the main actuator 132 being provided for moving various components of the chair 100, such as, for example, the back portion 104 of the chair 100, as well as the footrest portion 110 of the chair 100. The main actuator 132 is provided with a power cable 134, at a first end of which there is provided a suitable electrical connector 136 for electrically connecting the main actuator 132 to the DC power cable 128 as a result of the electrical connector 136 of the main actuator power cable 134 being electrically connected to a suitable electrical connector 138 which is provided upon a second opposite end of the DC power cable 128, whereby the main actuator 132 can now receive DC current from the DC power cable 128. In turn, as can best be seen in FIGS. 6 and 7, a headrest actuator 140 and a lumbar actuator 142 are respectively disclosed. The headrest actuator 140 and the lumbar actuator 142 are respectively provided with power cables 144,146, and it is seen that the distal ends of the power cables 144,146 are respectively provided with suitable electrical connectors 148,150 which are adapted to be respectively connected to suitable electrical connectors 152,154 which are mounted upon distal end portions of a headrest actuator power cable 156 and a lumbar actuator power cable 158, as shown in FIG. 5. In turn, the headrest actuator power cable 156 and the lumbar actuator power cable 158 are adapted to be electrically connected together by means of a first suitable junction connector 160 which is mounted upon a junction power cable 162 which, in turn, is adapted to be electrically connected to the main actuator power cable 134 by means of a second suitable junction connector 164. As can also be appreciated from FIGS. 4-6, the main actuator 132 comprises a drive motor 166, and a slider 168 which is adapted to be driven along the body of the main actuator 132 by means of the drive motor 166 so as to actuate or move the back portion 104 of the chair 100 and the footrest portion 110 of the chair 100, through means of conventional linkage systems, not shown, operatively connected to the slider 168. In a somewhat similar manner, it is seen that the headrest actuator 140 comprises a drive motor 170 and a telescopically movable tubular member 172 which is operatively connected to the headrest 108 and is extended outwardly from an outer tube of the actuator 140 and retracted back into the outer tube of the actuator 140 by means of the drive motor 170, while the lumbar actuator 142 comprises a drive motor 174 and a telescopically movable tubular member 176 which is operatively connected to the lumbar portion 106 and is extended outwardly from an outer tube of the actuator 142 and retracted back into the outer tube of the actuator 142 by means of the drive motor 174.

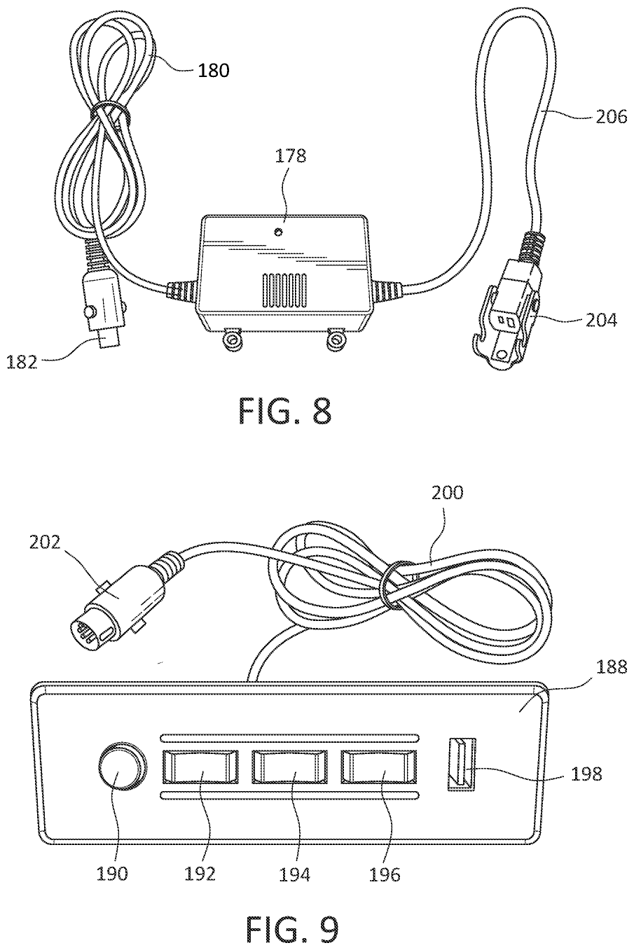

With reference now being made to FIG. 8, there is disclosed a control box 178 which is adapted to be electrically connected at a first end thereof to the main actuator 132 as illustrated within FIG. 5 by means of a first power cable 180 and a suitable electrical connector 182 which is adapted to be electrically connected to a suitable electrical connector 184 which is mounted upon the distal end of a power cable 186 which is electrically connected to the second junction connector 164, all as best seen in FIG. 5. Continuing further, and with reference being made to FIG. 9, a side switch housing 188 is disclosed and is seen to comprise various buttons 190,192,194,196, the functions of which will be discussed hereinafter, as well as a USB port 198 which is provided so as to provide a charging port for mobile devices such as, for example, a mobile phone. The side switch housing 188 is adapted to be mounted upon one side of the chair 100 illustrated within FIG. 1, and is provided with an electrical output signal cable 200 which has a suitable electrical connector 202 mounted upon its distal end for electrical connection to a complimentary electrical connector 204 which is mounted upon the distal end of a second power cable 206 which is connected to a second end portion of the control box 178. In this manner, electrical signals can be sent to the control box 178 when the various buttons 190,192,194,196 are depressed, as will be discussed more fully hereinafter, whereby, in turn, the control box 178 can then route control signals to the main actuator 132, the headrest actuator 140, or the lumbar actuator 142.

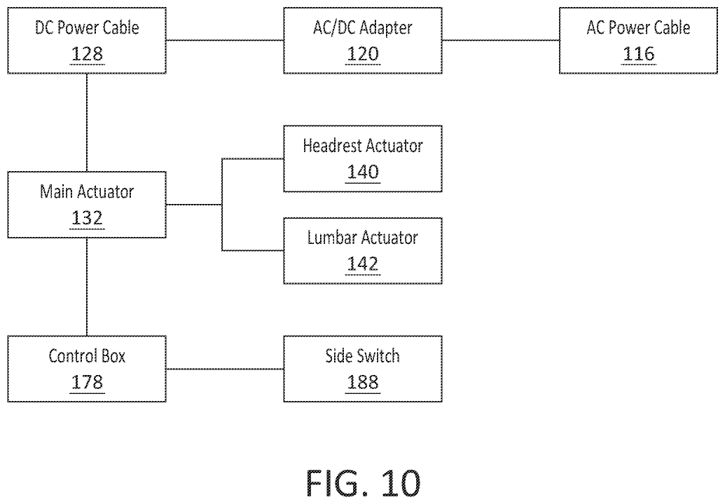

With reference lastly being made to FIG. 10, a block diagram schematically illustrates how all of the various components of the system, as illustrated within FIGS. 2-9, are electrically connected to each other in accordance with the principles and teachings of the present invention so as to provide the chair, as illustrated within FIG. 1, with the desired chair, headrest, and lumbar movements.

Having described all of the operative components of the system of the present invention, a brief description of how the various components operate so as to achieve the objectives of the present invention will now be provided. More particularly, with reference being made to FIG. 9, the various controls for the various operations of the chair 100 are mounted upon the side switch housing 188. Accordingly, when the user or person occupying the chair 100 depresses the button 190, a signal is sent from button 190 to the control box 178 so as to actuate the lumbar actuator 142. In accordance with a first mode of operation, the control box 178 can be programmed so that the lumbar actuator 142 will be extended and retracted in accordance with a predetermined repetitive cyclic mode so as to provide the user or person sitting in the chair 100 with a predetermined amount of massage. Depression of the button 190 a second time will terminate the cyclic movement of the lumbar actuator 142 so as to, in turn, terminate the massage operation of the lumbar actuator 142. Alternatively, in accordance with a second mode of operation, the control box 178 can be programmed so that the lumbar actuator 142 will be extended and retracted in accordance with a first predetermined repetitive cyclic mode so as to provide the user or person sitting in the chair 100 with a first predetermined amount of massage. Depression of the button 190 a second time will cause the lumbar actuator 142 to be extended and retracted in accordance with a second predetermined repetitive cyclic mode, which is different from the first predetermined repetitive cyclic mode, meaning shorter or longer periods of time between cycles, so as to provide the user or person sitting in the chair 100 with a second predetermined amount of massage. Still further, depression of the button 190 a third time will cause the lumbar actuator 142 to be extended and retracted in accordance with a third predetermined repetitive cyclic mode, which is different from the first and second predetermined repetitive cyclic modes, meaning still shorter or longer periods of time between cycles, so as to provide the user or person sitting in the chair 100 with a third predetermined amount of massage. Depression of the button 190 a fourth time will terminate the cyclic movement of the lumbar actuator 142 so as to, in turn, terminate the massage operation of the lumbar actuator 142. In this manner, the lumbar actuator 142 is able to provide the user, seated in the chair 100 or similar furniture piece, with a massage that will promote blood circulation, comfort, and physical and mental relaxation.

With reference continuing to be made to FIG. 9, button 192 is a toggle switch that controls the headrest actuator 140. When the user or person occupying the chair 100 depresses and holds the left side of the button 192, the headrest actuator 140 will be continuously actuated so as to move the headrest 108 of the chair 100 to a forward position desired by the user or occupant of the chair 100. Alternatively, depressing and holding the right side of the button 192 will continuously retract the headrest actuator 140 back toward its original START position, it being appreciated that any position between fully extended and fully retracted states of the headrest actuator 140 of course be achieved as desired by the user or occupant of the chair 100. In a similar manner, when the user or person occupying the chair 100 depresses and holds the left side of the button 194, which is also a toggle switch, the lumbar actuator 142 will be continuously actuated so as to move the lumbar support 106 of the chair 100 to a forward position desired by the user or occupant of the chair 100. Alternatively, depressing and holding the right side of the button 194 will continuously retract the lumbar actuator 142 back toward its original START position, it being appreciated that any position between fully extended and fully retracted states of the headrest actuator 142 of course be achieved as desired by the user or occupant of the chair 100. In this manner, predetermined degrees of support and comfort to the lumbar region of the back of the person sitting in the chair 100 can be readily provided. Continuing still further, when the user or person occupying the chair 100 depresses and holds the left side of the button 196, the main actuator 132 will be continuously actuated so as to move the slider 168 of the main actuator 132 toward the motor end 166 of the actuator so as to deploy or move, for example, the back portion 104 of the chair 100 as well as the foot portion 110 of the chair 100. Alternatively, depressing and holding the right side of the button 196 will activate the main actuator 132 such that the slider 168 will be continuously returned to its original START position as illustrated within FIG. 5, it being appreciated that any position between fully extended and fully retracted states of the main actuator 132 can of course be achieved as desired by the user or occupant of the chair 100. Lastly, it is noted that the side switch housing 188 also includes a USB port 198 such that mobile devices, such as, for example, a mobile phone or other electronic device, can be plugged into the USB port so as to be recharged as necessary. FIG. 10 is a schematic block diagram showing all of the various electrical interconnections defined between the various components as has been previously described.

Obviously, many variations and modifications of the present invention are possible in light of the above teachings. It is therefore to be understood that within the scope of the appended claims, the present invention may be practiced otherwise than as specifically described herein.

What is claimed is:

1. An auto cycle lumbar massage system for a piece of furniture, comprising:
a seat portion;
a back portion;
a lumbar support portion; and
a lumbar actuator operatively connected to said lumbar support portion of said piece of furniture for extending and retracting said lumbar support portion of said piece of furniture in accordance with a predetermined repetitive cyclic mode of operation so as to effectively provide massage therapy to the lumbar region of a person's back when the person is seated upon said piece of furniture.

2. The system as set forth in claim 1, further comprising:
a control box mounted within said piece of furniture; and
a side switch housing mounted upon a side of said furniture piece and comprising a first button which, when depressed, transmits a signal to said control box which, in turn, transmits a signal to said lumbar actuator so as to actuate said lumbar support portion of said piece of furniture in accordance with a predetermined repetitive cyclic mode of operation so as to effectively provide massage therapy to the lumbar region of a person's back when the person is seated upon said piece of furniture.

3. The system as set forth in claim 2, wherein:
depression of said first button which, when depressed a multiplicity of times, transmits signals to said control box which, in turn, transmits signals to said lumbar actuator so as to actuate said lumbar support portion of said piece of furniture in accordance with a plurality of different predetermined repetitive cyclic modes of operation, as selected by the person seated upon said piece of furniture, so as to effectively provide massage therapy to the lumbar region of a person's back, in accordance with different frequencies of activation of said lumbar actuator, when the person is seated upon said piece of furniture so as to achieve different degrees of massage and relaxation to the person seated upon said piece of furniture.

4. The system as set forth in claim 2, further comprising:
a footrest portion;
a main actuator operatively connected to said back portion and said footrest portion; and
a second button mounted upon said side switch housing and operatively connected to said control box such that when said second button is depressed, a signal is sent to said control box so as to actuate said main actuator for moving said footrest and back portions of said furniture piece toward extended or retracted positions.

5. The system as set forth in claim 2, further comprising:
a headrest portion;
a headrest actuator operatively connected to headrest portion; and
a third button mounted upon said side switch housing and operatively connected to said control box such that when said third button is depressed, a signal is sent to said control box so as to actuate said headrest actuator for moving said headrest of said furniture piece toward extended or retracted positions.

6. The system as set forth in claim 2, further comprising:
a fourth button mounted upon said side switch housing and operatively connected to said control box such that when said fourth button is depressed, a signal is sent to said control box so as to actuate said lumbar actuator for moving said lumbar portion of said furniture piece toward extended or retracted positions.

7. The system as set forth in claim 2, further comprising:
a USB port provided upon said side switch housing for permitting mobile devices to be connected to said USB port in order to recharge said mobile devices.

8. The system as set forth in claim 1 wherein:
said piece of furniture comprises a lounger chair.
